(19) United States
(12) Patent Application Publication
(10) Pub. No.: US 2017/0174336 A1
(43) Pub. Date: Jun. 22, 2017

(54) AERIAL VEHICLE

(71) Applicants: NIPPON SOKEN, INC., Nishio-city (JP); DENSO CORPORATION, Kariya-city (JP)

(72) Inventors: Hiroyasu BABA, Nishio-city (JP); Koji KAWASAKI, Nishio-city (JP); Takenori MATSUE, Nishio-city (JP)

(21) Appl. No.: 15/379,554

(22) Filed: Dec. 15, 2016

(30) Foreign Application Priority Data
Dec. 16, 2015 (JP) 2015-245265

(51) Int. Cl. B64C 27/08; B64C 1/30; B64C 39/02

(52) U.S. Cl. CPC B64C 27/08; B64C 39/024; B64C 1/30; B64C 2201/024; B64C 2201/108; B64C 2201/042; B64C 2201/165

(57) ABSTRACT

An aerial vehicle is provided which includes first thrusters with first propellers and second thrusters with second propellers. Each of the first propellers has a first rotating region in which blades thereof rotate. Similarly, each of the second propellers has a second rotating region in which blades thereof rotate. Each of the first rotating regions is located to overlap one of the second rotating regions, as viewed in a direction of a yaw axis of the aerial vehicle. The first rotating regions are located away from the second rotating regions in the direction of the yaw axis. Such layout of the first and second propellers eliminates physical interference therebetween. The overlap between the first and second propellers results in a decreased cross-sectional area of projection of the aerial vehicle from the front view in a flight direction thereof.

### CROSS REFERENCE TO RELATED DOCUMENT

The present application claims the benefit of priority of Japanese Patent Application No. 2015-245265 on Dec. 16, 2015, the disclosure of which is incorporated herein by reference.

### BACKGROUND

1 Technical Field

The invention relates generally to an aerial vehicle.

2 Background Art

Aerial vehicles commonly known as drones are equipped with a plurality of thrusters to produce propulsive power for ascent. The thrusters of the aerial vehicle are arranged without overlaps of propellers in order to generate an adequate propulsive force. Japanese Patent First Publication No. 2014-240242 teaches thrusters of an aerial vehicle which have propellers which are arranged in two circles. The thrusters have the propellers disposed at intervals away from each other without any physical interference among them.

The layout of the thrusters without any overlap of regions of rotation of the propellers, however, results in an increase in area of projection thereof in front of or lateral sides of the aerial vehicle in a direction of flight thereof. Specifically, when the aerial vehicle is viewed from the front or side thereof, it will result in an increased area of occupation of the aerial vehicle. The flight of the aerial vehicle, therefore, needs an open space wider than the area of projection thereof. This leads to the problem that the aerial vehicles are subjected to limitations of flight in, for example, buildings or spaces with obstacles.

### SUMMARY

It is therefore an object to provide an aerial vehicle designed to have a decreased area of projection thereof, as viewed from the front in a direction of flight of the aerial vehicle, and also have a decreased space required for the flight thereof.

According to one aspect of the disclosure, there is provided an aerial vehicle which comprises: (a) a vehicle body which is disposed at the center of gravity of the aerial vehicle; (b) a pair of first arms which extend radially outward from the vehicle body to be symmetrical with each other; (c) first thrusters which are mounted on ends of the first arms, respectively; (d) first propellers which are disposed on the first thrusters and rotate in first rotating regions to produce propulsive power; (e) a pair of second arms which extend radially outwardly from the vehicle body to be symmetrical with each other; (f) second thrusters which are mounted on ends of the second arms; and (g) second propellers which are disposed on the second thrusters and rotate in second rotating regions to produce propulsive power. The second propellers are arranged so that a plane extending to include the second rotating regions is located away from a plane extending to include the first rotating regions in a direction of a yaw axis of the vehicle body. The second rotating regions overlap the first rotating region when the vehicle body is projected in the direction of the yaw axis.

The overlap between the first rotating regions of the first propellers and the second rotating regions of the second propellers in the direction of the yaw axis of the aerial vehicle and the separation of the first regions and the second regions from each other in the direction of the yaw axis result in a decreased area of projection of the aerial vehicle, as viewed from the front in a flight direction thereof and eliminate physical interference of the first and second propellers with each other. This leads to a decrease in space in the air required by the aerial vehicle to fly, thus facilitating ease with which the aerial vehicle flies within narrow flight spaces such as inside complicated structures or structures in which there are many obstacles.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a schematic diagram which illustrates an aerial vehicle according to the first embodiment, as viewed from above in a direction of a yaw axis thereof;

FIG. 2 is a schematic diagram of the aerial vehicle, as viewed from an arrow II in FIG. 1;

FIG. 3 is a vertical sectional view of the aerial vehicle, as taken along the line III-III in FIG. 1;

FIG. 4 is a schematic diagram of a conventional aerial vehicle, as viewed from above in a direction of yaw axis thereof;

FIG. 5 is a schematic diagram which illustrates an aerial vehicle according to the second embodiment, as viewed from above in a direction of a yaw axis thereof;

FIG. 6 is a schematic side view which illustrates an aerial vehicle according to the third embodiment;

FIG. 7 is a schematic diagram which illustrated the aerial vehicle of FIG. 6 when an angle which a first arm makes with a second arm is zero;

FIG. 8 is a schematic side diagram of the aerial vehicle, as viewed in a direction of an arrow VIII in FIG. 7;

FIG. 9 is a schematic diagram which illustrated an aerial vehicle according to the fourth embodiment, as viewed from above in a direction of a yaw axis thereof; and

FIG. 10 is a schematic diagram of the aerial vehicle, as viewed from a direction of an arrow X in FIG. 9.

### DESCRIPTION OF THE PREFERRED EMBODIMENTS

Embodiments of an aerial vehicle will be described below with reference to the drawings. Like reference numbers employed throughout the drawings refer to like parts, and explanation thereof in detail will be omitted in embodiments following the second embodiment.

### First Embodiment

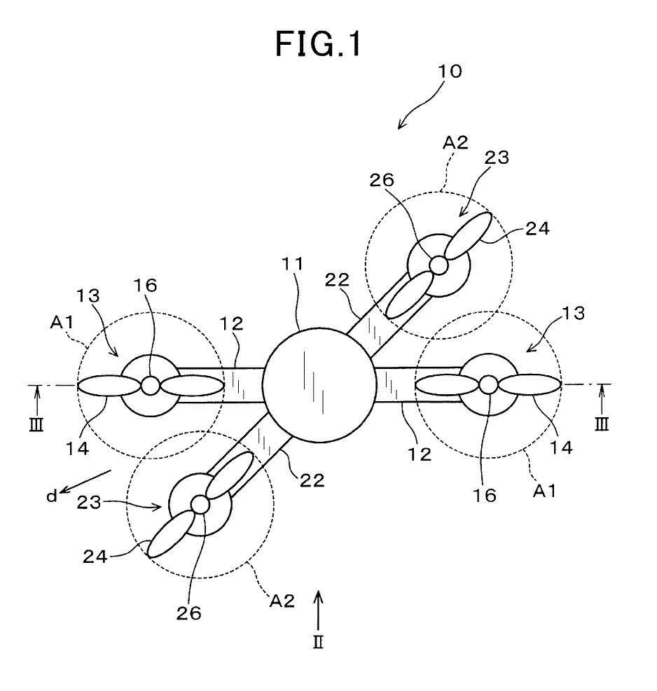

The aerial vehicle 10, as illustrated in FIGS. 1 to 3, includes the vehicle body 11, the first arms 12, the first thrusters 13, and the first propellers 14. The vehicle body 11 is located at the center of gravity of the aerial vehicle 10. The first arms 12 radially extend from the vehicle body 11 to be symmetrical about the vehicle body 11. The first arms 12 are provided as a pair on the vehicle body 11. Each of the first thrusters 13 is secured to one end of a corresponding one of the first arms 12 which is opposite the other end to which the vehicle body 11 is joined. The first propellers 14 rotate on the first thrusters 13 to produce propulsive power of the aerial vehicle 10. The first thrusters 13 each have the motor 15 as a drive source to rotate the first propeller 14. The torque, as produced by each of the motors 15, is transmitted to one of the first propellers 14 through the first shaft 16.

The aerial vehicle 10 also includes the second arms 22, the second thrusters 23, and the second propellers 24. The second arms 22 radially extend from the vehicle body 11 to be symmetrical about the vehicle body 11. The second arms 22 are provided as a pair on the vehicle body 11. Each of the second thrusters 23 is secured to one end of a corresponding one of the second arms 22 which is opposite the other end to which the vehicle body 11 is joined. The second propellers 24 rotate on the second thrusters 23 to produce propulsive power of the aerial vehicle 10. The second thrusters 23 each have the motor 25 as a drive source to rotate the second propeller 24. The torque, as produced by each of the motors 25, is transmitted to one of the second propellers 24 through the second shaft 26.

The vehicle body 11 has the control unit 31 and the electrical storage device 32 disposed therein. The control unit 31 is equipped with the inertia determiner 33 and the microcomputer 34. The inertia determiner 33 is equipped with various sensors, such as an accelerator sensor, an angular velocity sensor, and an altitude sensor, not shown, which work to measure a flight attitude and a flight altitude of the aerial vehicle 10. The microcomputer 34 is made up of a CPU, a ROM, and a RAM, not shown, and executes a computer program to control an overall operation of the aerial vehicle 10 including the first thrusters 13 and the second thrusters 23 using the flight attitude and the flight altitude, as derived by the inertia determiner 33. The electrical storage device 32 is implemented by a secondary battery, such as a lithium ion battery or a nickel hydride battery, or a capacitor. The electrical storage device 32 stores therein electrical energy to be supplied to the motor 15 of the first thrusters 13 and the motor 25 of the second thrusters 23.

In the first embodiment, the first propellers 14 and the second propellers 24 have rotating regions deviated from each other in a yaw axis of the aerial vehicle 10 (i.e., the vehicle body 11). Specifically, a plane including a region of rotation of blades of each of the first propellers 14 is separate from a plane including a region of rotation of blades of each of the second propellers 24 in the yaw axis of the aerial vehicle 10. Additionally, when the aerial vehicle 10 is projected in the direction of the yaw axis, for example, from the upper end thereof in the direction of the yaw axis, the rotating region A1 of each of the first propellers 14, as illustrated in FIG. 1, partially overlaps the rotating region A2 of one of the second propellers 24.

As described already, the plane including the rotating region A1 of each of the first propellers 14 is located away from the plane including the rotating region A2 of each of the second propellers 24 in the yaw axis of the aerial vehicle 10 (i.e., the vehicle body 11). This eliminates physical interference between the first propellers 14 and the second propellers 24 even though the rotating region A1 of each of the first propellers 14 partially overlaps the rotating region A2 of one of the second propellers 24 when the aerial 1 is projected in the direction of the yaw axis. In the first embodiment, the second shafts 26 each have a length extending in the direction of the yaw axis which is longer than that of the first shafts 16, so that the rotating regions A1 of the first propellers 14 are separate from the rotating regions A2 of the second propellers 24 in the direction of the yaw axis.

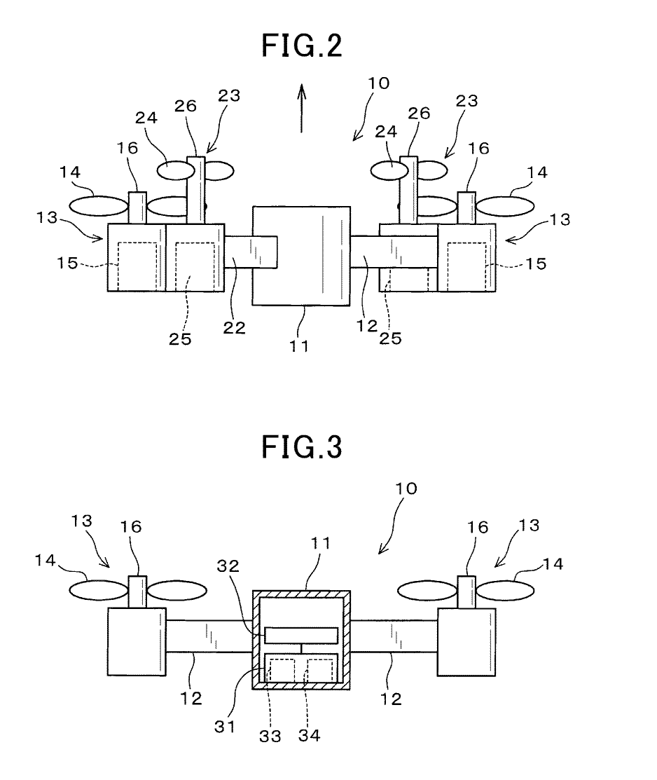

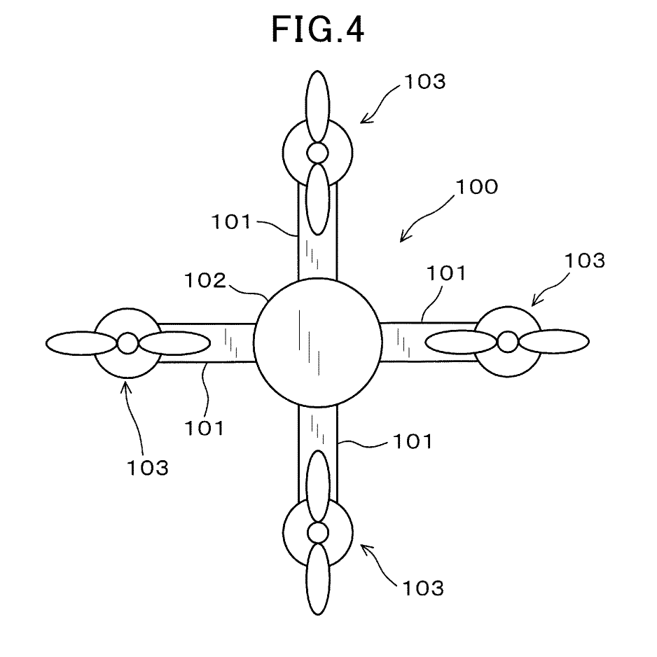

The aerial vehicle 10 is engineered to fly in the air, as illustrated in FIG. 2, vertically along the yaw axis and also back and forth and around in directions perpendicular to the yaw axis. In the following discussion, it is assumed that the aerial vehicle 10 flies, as illustrated in FIG. 1, in a direction, as indicated by an arrow d, which will also be referred to below as a flight direction d. When the aerial vehicle 10 is projected from the front view in the flight direction d, the projected area of the aerial vehicle 10 will be smaller than that of the conventional aerial vehicle 100 shown in FIG. 4 because the rotating regions A1 of the first propellers 14 overlap the rotating regions A2 of the second propellers 24. The conventional aerial vehicle 100 has the arms 101 arranged at a regular interval of 90° away from each other in the circumferential direction of the vehicle body 102. The aerial vehicle 100 is equipped with the thrusters 103 disposed on the front ends of the arms 101. When being projected from the front view in the flight direction, the aerial vehicle 10 of the first embodiment has the projected area which is smaller in size than that of the conventional aerial vehicle 100 of FIG. 4. This enables the aerial vehicle 10 to fly around obstacles within narrow flight spaces such as inside complicated structures or structures in which there are lots of obstacles.

As apparent from the above discussion, the aerial vehicle 10 is designed to have the first propellers 14 and the second propellers 24 arranged to have the rotating regions A1 and the rotating regions A2 which partially overlap each other when the aerial vehicle 100 is projected in the direction of the yaw axis. Each of the rotating regions A1 of the first propellers 14 and each of the rotating regions A2 of the second propellers 24 lie at locations different from each other in the direction of the yaw axis. The above layout eliminates the physical interference of the first and second propellers 14 and 24. The overlap between the rotating regions A1 of the first propeller 14 and the rotating regions A2 of the second propellers 24 results in a decreased cross-sectional area of projection of the aerial vehicle 10 from the front view in the flight direction thereof. This leads to a decrease in space required by the aerial vehicle 10 to fly, thus facilitating ease with which the aerial vehicle 10 flies within narrow flight spaces such as insides of complicated structures or structures in which there are lots of obstacles.

### Second Embodiment

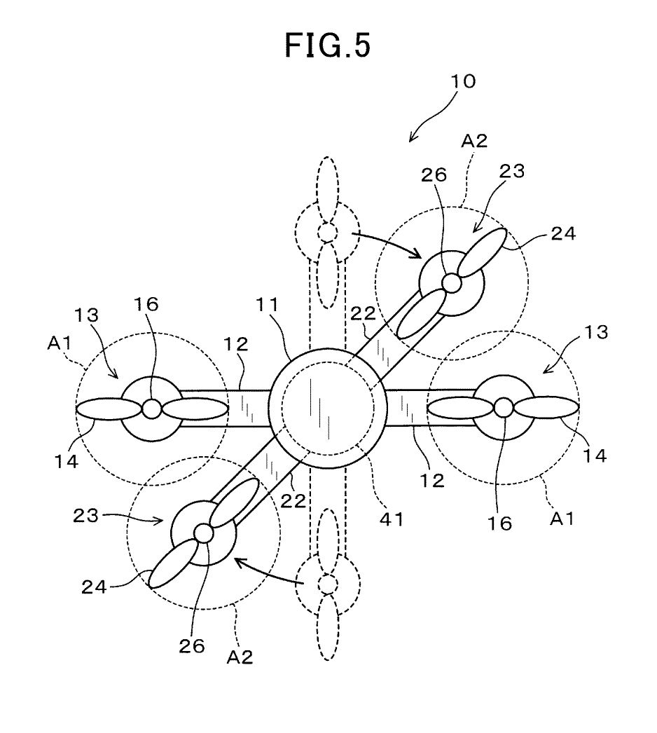

FIG. 5 shows the aerial vehicle 10 according to the second embodiment.

The aerial vehicle 10 is equipped with the drive unit 41. The drive unit 41 is installed inside the vehicle body 11. The drive unit 41 works as an actuator to swivel the first arms 12 and the second arms 22 relative to each other around the yaw axis. Specifically, the drive unit 41 rotates the first arms 12 and the second arms 22 relative to each other in a range from an angular position where the angle which the each of the first arms 12 makes with one of the second arms 22, as indicated by broken lines in FIG. 5, is 90° to an angular position where the each of the first arms 12 makes with one of the second arms 22, as indicated by solid lines in FIG. 5, is less than 90°. The drive unit 41 in the second embodiment is designed to swivel only the second arms 22 about the yaw axis.

When the first arms 12 and the second arms 22 are oriented so as to be at 90° to each other, and the vehicle body 11 is projected in the direction of the yaw axis, the rotating regions A1 of the first propellers 14 are out of overlap with the rotating regions A2 of the second propellers 24. This causes the propulsive power, as produced by both the first propellers 14 and the second propellers 24 to be fully used for flight of the aerial vehicle 10. When the first arms 12 and the second arms 22 are oriented so as to make less than 90° with each other, and the vehicle body 11 is projected in the direction of the yaw axis, the rotating regions A1 of the first propellers 14 and the rotating regions A2 of the second propellers 24 overlap each other. This causes a portion of propulsive power, as produced by the second propellers 24 located above the first propellers 12 in the direction of the yaw axis, not to be used for flight of the aerial vehicle 10, but however, the overlap between the rotating regions A1 of the first propellers 14 and the rotating regions A2 of the second propellers 24, as described already, results in a decreased area of projection of the aerial vehicle 10 from the front view in the flight direction thereof. This enables the aerial vehicle 10 to fly in a narrow space.

The aerial vehicle 10 of the second embodiment is, as described above, capable of turning the first arms 12 and the second arms 22 relative to each other about the yaw axis using the drive unit 41 to change and fix the angle which the first arms 21 on which the first propellers 14 are disposed make with the second arms 22 on which the second propellers 24 are disposed. In other words, the aerial vehicle 10 is capable of selecting the angle between each of the first arms 21 and one of the second arms 22 to be a value suitable for the size of space in which the aerial vehicle 10 flies to change the size of space occupied by the aerial vehicle 10.

### Third Embodiment

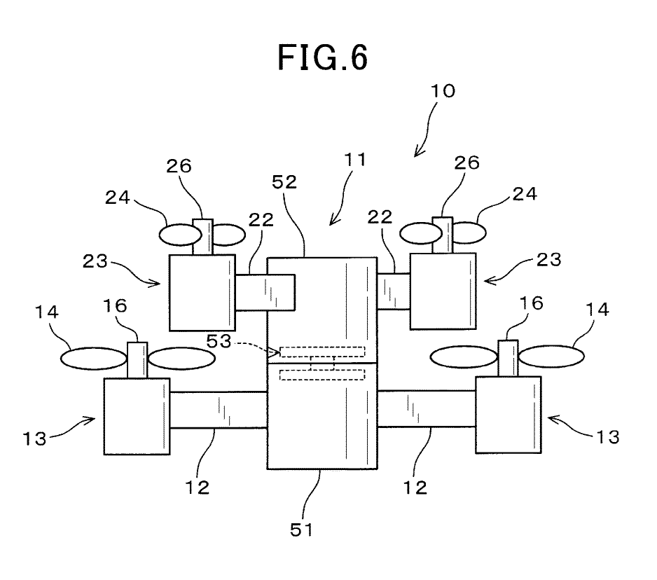

FIG. 6 shows the aerial vehicle 10 according to the third embodiment.

The vehicle body 11 is made up of two discrete parts: the first body 51 and the second body 52 which are joined together at the center of a length of the vehicle body 11 extending in the yaw axis of the aerial vehicle 10. The first body 51 has secured thereto the first arms 12 on which the first thrusters 13 are disposed. The second body 52 has secured thereto the second arms 22 on which the second thrusters 23 are mounted. The first body 51 and the second body 52 are rotatable relative to each other at the center of the vehicle body 11 in the lengthwise direction (i.e., the direction of the yaw axis) to orient the first thrusters 12 secured to the first arms 12 and the second thrusters 23 secured to the second arms 22 to be arranged out of alignment with each other in the direction of the yaw axis. Accordingly, the plane including the rotating region A1 of each of the first propellers 14 is, like in the first embodiment, located away from the plane including the rotating region A2 of each of the second propellers 24 in the yaw axis of the aerial vehicle 10 (i.e., the vehicle body 11), thereby eliminating the physical interference of the first and second propellers 14 and 24. The above structure of the vehicle body 10 enables the first shafts 16 and the second shafts 26 to have the same length.

The aerial vehicle 10 includes the drive unit 53 disposed inside the vehicle body 11, more specifically, in the first and second bodies 51 and 55. The drive unit 53 works as an actuator to rotate the first body 51 and the second body 52 relative to each other about the yaw axis. Specifically, the drive unit 53 changes a relative angle between the first body 51 and the second body 52 about the yaw axis to rotate the first arms 12 and the second arms 22 relative to each other in a range from an angular position where the angle which each of the first arms 12 makes with one of the second arms 22, as indicated by broken lines in FIG. 5, is 90° to an angular position where the angle each of the first arms 12 makes with one of the second arms 22, as indicated by solid lines in FIG. 5, is less than 90°.

When the angle which the first arms 12 make with the second arms 22 is less than 90°, e.g., 45° or less, and the vehicle body is projected in the direction of the yaw axis, the rotating regions A1 of the first propellers 14 overlap the rotating regions A2 of the second propellers 24. Specifically, the drive unit 53 rotates the first body 51 and the second body 52 relative to each other to change the angle which each of the first arms 12 makes with one of the second arms 22. When the first arms 12 and the second arms 22 are oriented so as to make an angle of 90° with each other, and when the vehicle body 11 is projected in the direction of the yaw axis, the rotating regions A1 of the first propellers 14 are out of overlap with the rotating regions A2 of the second propellers 24. This causes the propulsive power, as produced by both the first propellers 14 and the second propellers 24 to be fully used for flight of the aerial vehicle 10. Alternatively, when the first arms 12 and the second arms 22 are oriented so as to make an angle of less than 90° with each other, and when the vehicle body 11 is projected in the direction of the yaw axis, the rotating regions A1 of the first propellers 14 and the rotating regions A2 of the second propellers 24 at least partially overlap each other. This causes a portion of propulsive power, as produced by the second propellers 24 located above the first propellers 12 in the direction of the yaw axis, not to be used for flight of the aerial vehicle 10, but however, the overlap between the rotating regions A1 of the first propellers 14 and the rotating regions A2 of the second propellers 24, as described already, results in a decreased area of projection of the aerial vehicle 10 from the front view in the flight direction thereof. This enables the aerial vehicle 10 to fly in a narrow space.

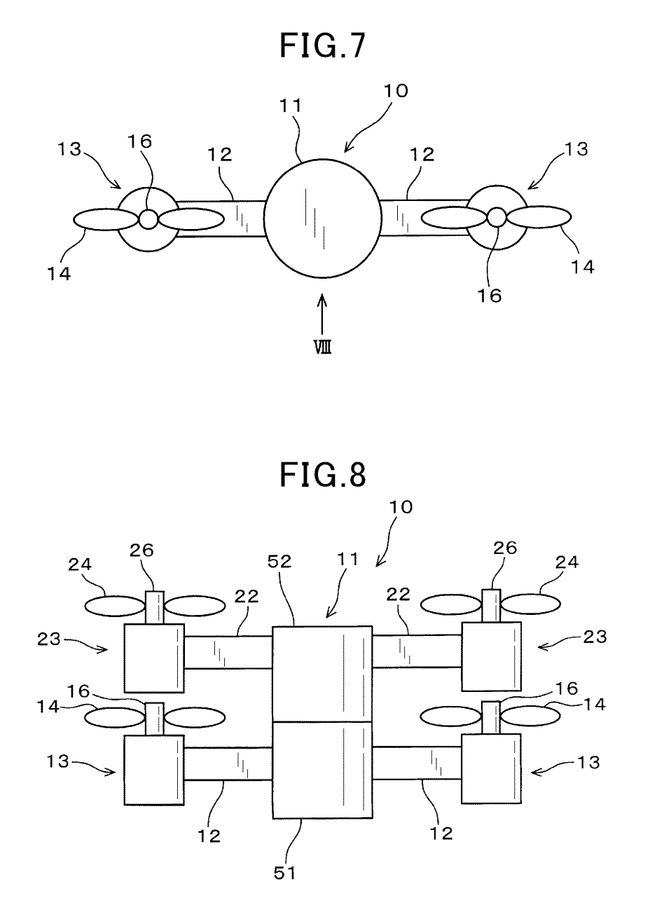

The drive unit 53 is, as illustrated in FIGS. 7 and 8, capable of orienting the first arms 12 and the second arms 22 so as to fully overlap each other, so that the angle between each of the first arms 12 and one of the second arms 22 is approximately zero (0°). This layout causes the rotating regions A1 of the first propellers 14 and the rotating regions A2 of the second propellers 24 to be fully aligned with each other in the direction of the yaw axis of the aerial vehicle 10 when the aerial vehicle 10 is projected in the direction of the yaw axis. This minimizes the size of space occupied by the aerial vehicle 10, thus facilitating handling of the aerial vehicle 10 when not used for flight, for example, when transported or placed in storage.

The vehicle body 11 of the third embodiment is, as described above, designed to have the vehicle body 10 made up of two discrete parts: the first body 51 and the second body 52 joined together. The first body 51 and the second body 52 are capable of being rotated relative to each other around the yaw axis (i.e., the longitudinal center line of the vehicle body 10) to change the angle between each of the first arms 12 and one of the second arms 22. The plane including the rotating region A1 of each of the first propellers 14 installed on the first thrusters 13 is located away from the plane including the rotating region A2 of each of the second propellers 24 installed on the second thrusters 23 in the yaw axis of the aerial vehicle 10. This eliminates physical interference between the first propellers 14 and the second propellers 24 even though the rotating region A1 of each of the first propellers 14 partially overlaps the rotating region A2 of one of the second propellers 24 when the aerial vehicle 10 is projected in the direction of the yaw axis.

The first body 51 and the second body 52 are, as described above, rotated by the drive unit 53 around the yaw axis of the aerial vehicle 10. In other words, the angle which each of the first arms 12 joined to the first propellers 14 and one of the second arms 24 joined to the second propellers 24 make with each other is selectable using the drive unit 53 to be a value suitable for conditions of space in the air required by the aerial vehicle 10 to fly and to change the size of space occupied by the aerial vehicle 10 in the air.

The drive unit 53 is, as described already capable of orienting the first arms 12 and the second arms 22 so as to fully overlap each other, in other words, change the angle between each of the first arms 12 and one of the second arms 22 to approximately zero (0°). This layout causes the rotating regions A1 of the first propellers 14 and the rotating regions A2 of the second propellers 24 to fully overlap each other in the direction of the yaw axis of the aerial vehicle 10 when the aerial vehicle 10 is projected in the direction of the yaw axis. This minimizes the size of space in the air occupied by the aerial vehicle 10, thus facilitating handling of the aerial vehicle 10 when not used for flight, for example, when transported or placed in storage.

### Fourth Embodiment

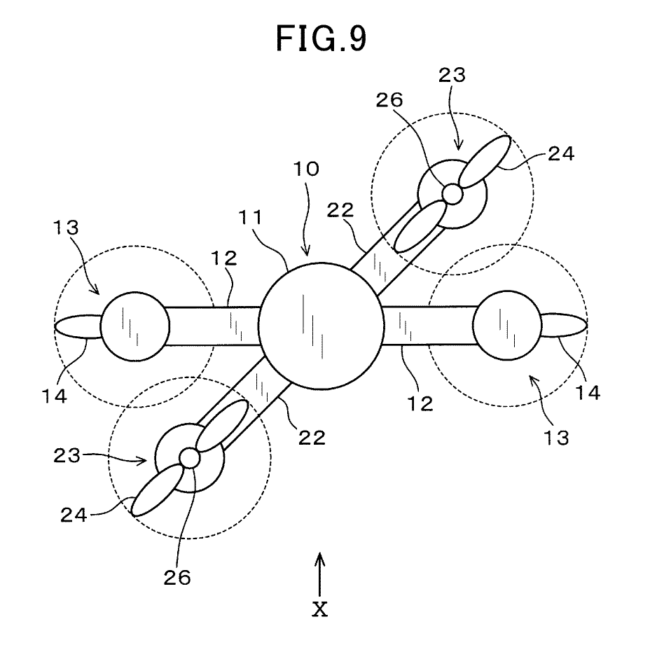

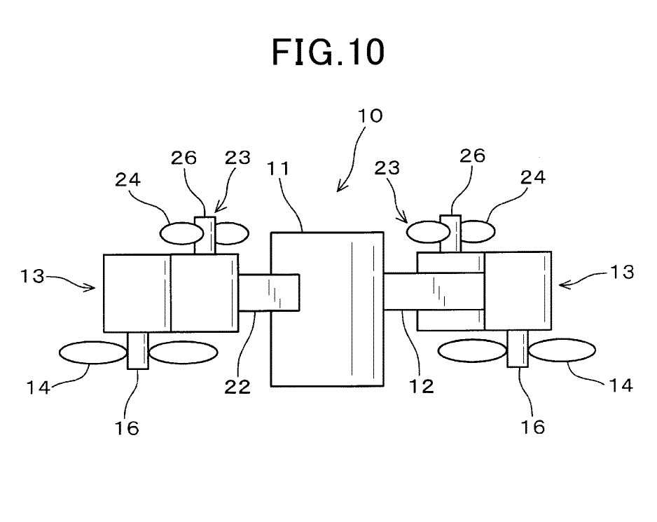

FIGS. 9 and 10 show the aerial vehicle 10 according to the fourth embodiment.

The first propellers 14 and the second propellers 24 are different in orientation from each other in the direction of the yaw axis, in other words, they are disposed to be symmetrical with respect to a line extending perpendicular to the yaw axis of the vehicle body 11. Specifically, the first thrusters 13 equipped with the first propellers 14 and the second thrusters 23 equipped with the second propellers 24 are oriented in opposite directions along the yaw axis of the aerial vehicle 10. In other words, the first shafts 16 of the first thrusters 13, as can be seen in FIG. 10, extend in a direction opposite that in which the second shafts 26 of the second thrusters 23 extend. The rotating regions A1 of the first propellers 14 are, thus, located below the first arms 12 in the direction of the yaw axis, while the rotating regions A2 of the second propellers 24 are located above the second arms 22.

The above layout places the first propeller 14 and the second propellers 24 to be separate from each other in the direction of the yaw axis. Specifically, the plane including the rotating region A1 of each of the first propellers 14 installed on the first thrusters 13 is located away from the plane including the rotating region A2 of each of the second propellers 24 installed on the second thrusters 23 in the yaw axis of the aerial vehicle 10. Additionally, when the vehicle body 11 is projected in the direction of the yaw axis, for example, from the upper end thereof in the direction of the yaw axis, the rotating region A1 of each of the first propellers 14, as illustrated in FIG. 9, partially overlaps the rotating region A2 of one of the second propellers 24.

The aerial vehicle 10 of the fourth embodiment is designed to have the first arms and the second arms 22 arranged between the rotating regions A1 of the first propeller 14 and the rotating regions A2 of the second propellers 24. Such layout results in an increased distance between the rotating regions A1 of the first propeller 14 and the rotating regions A2 of the second propellers 24. This eliminates physical interference between the first propellers 14 and the second propellers 24 even though the rotating region A1 of each of the first propellers 14 overlaps the rotating region A2 of one of the second propellers 24 in the direction of the yaw axis and also eliminates limitations to the length of the first shaft 16 and the second shaft 26.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiment which can be embodied without departing from the principle of the invention as set forth in the appended claims.

What is claimed is:

1. An aerial vehicle comprising:
a vehicle body which is disposed at the center of gravity of the aerial vehicle;
a pair of first arms which extend radially outward from the vehicle body to be symmetrical with each other;
first thrusters which are mounted on ends of the first arms, respectively;
first propellers which are disposed on the first thrusters and rotate in first rotating regions to produce propulsive power;
a pair of second arms which extend radially outwardly from the vehicle body to be symmetrical with each other;
second thrusters which are mounted on ends of the second arms; and
second propellers which are disposed on the second thrusters and rotate in second rotating regions to produce propulsive power, the second propellers being arranged so that a plane extending to include the second rotating regions is located away from a plane extending to include the first rotating regions in a direction of a yaw axis of the vehicle body, the second rotating regions overlapping the first rotating region when the vehicle body is projected in the direction of the yaw axis.

2. An aerial vehicle as set forth in claim 1, further comprising a drive unit which works to rotate the first arms and the second arms relative to each other around the yaw axis of the vehicle body.

3. An aerial vehicle as set forth in claim 1, wherein the vehicle body is made up of a first body and a second body joined together to define a length of the vehicle body extending along the yaw axis, and wherein the first body has the first arms secured thereto, the second body having the second arms secured thereto.

4. An aerial vehicle as set forth in claim 3, further comprising a drive unit which works to rotate the first body and the second body relative to each other around the yaw axis of the vehicle body.

5. An aerial vehicle as set forth in claim 4, wherein when projected in the direction of the yaw axis, the first rotating regions of the first propellers mounted on the first arms and the second rotating regions of the second propellers mounted on the second arms are aligned with each other.

6. An aerial vehicle as set forth in claim 1, wherein the first propellers of the first thrusters and the second propellers of the second thrusters are disposed to be symmetrical with respect to a line extending perpendicular to the yaw axis of the vehicle body.
